(19) United States
(12) Patent Application Publication
(10) Pub. No.: US 2011/0173298 A1
(43) Pub. Date: Jul. 14, 2011

(54) Method for Organizing Business Card

(76) Inventor: Ky Sung NAM, Tujunga, CA (US)

(21) Appl. No.: 12/684,619

(22) Filed: Jan. 8, 2010

(51) Int. Cl. G06F 15/16

(52) U.S. Cl. 709/219

(57) ABSTRACT

A method for organizing business cards is provided. The method includes steps of: creating a first business card for a first user; transmitting information of the first business card to a server and registering on the server with a first registration number; handing out the first business card with the registration number printed to a second user; logging on to the server with the second registration and related log-in identification and password and providing the first registration number to the server; and having the information stored and organized in the second electronic business card book accessible remotely using an Internet browser or email systems.

### BACKGROUND OF THE INVENTION

The present invention relates to a method for organizing business. More particularly, this invention relates to a method and a system for organizing business, which helps the user to organize and utilize the business cards efficiently.

Business cards are used widely among people, but the growing stack of business cards may be very challenging to organize and utilize due to its inconvenient form.

An album-type business card organizer works just for a collecting space for the business cards, which can be again very awkward to handle or use. As the tome gets bigger with the increasing number of cards, it is going to be impossible to bring it around.

Accordingly, a need for a method for organizing business has been present for a long time considering the mass flow of business cards. This invention is directed to solve these problems and satisfy the long-felt need.

### SUMMARY OF THE INVENTION

The present invention contrives to solve the disadvantages of the prior art.

An object of the invention is to provide a method for organizing business.

Another object of the invention is to provide a method for organizing business, which helps the user to organize and utilize the business cards efficiently.

Still another object of the invention is to provide a method for organizing business, which uses a server for organizing and utilizing the business cards.

An aspect of the invention provides a method for organizing business cards.

The method comprises steps of: creating a first business card associated with a first user; transmitting information of the first business card to a server and registering on the server with a first registration number, wherein the first business card comprises the first registration number; handing out the first business card to a second user; the second user's logging on to the server with log-in identification and password and providing the first registration number to the server for organizing information of the first business card in a second electronic business card book; and the second user's having the information stored and organized in the second electronic business card book accessible remotely using a mobile communication device.

The transmitted information in the step of transmitting may comprise a physical business card, digitized visual information, and text information.

The step of transmitting may comprise steps of scanning, digitizing, and organizing-and-uploading on the server.

The mobile communication device may comprise a cellular phone, a personal digital assistant, an e-book reader, an Internet browser, and an email system based on an Internet browser or a mobile communication network.

The step of organizing may comprise steps of categorizing, sorting, and searching according to a plurality of criteria.

The plurality of criteria may comprise type of business, name of owner, region, and specialty.

The step of creating may comprise steps of designing and creating a physical business card or a digital business card.

The digital business card may be downloaded and utilized by the mobile communication device.

The digital business card may comprise a plurality of clickable zones configured to be displayed in the mobile communication device.

The server may be associated with an Internet website.

The Internet website may be accessed by the second user with a first registration number in order to access and utilize information associated with the first business card.

The method may further comprise steps of downloading information associated with a specific business card and displaying an image of the specific business card on the mobile communication device.

The Internet website may provide a service of accepting a plurality of business cards from the second user and inputting and organizing the processed information on the plurality of business cards in the second electronic business card book.

The business card may further comprise information on the Internet website along with the registration number.

The step of handing out may comprise steps of sending the first registration number or a digital image of the first business card having the first registration number electronically, and inputting the first registration number to the second user's mobile communication device directly.

Another aspect of the invention provide a system for organizing business cards.

The system comprises a server and an electronic business card book.

The server is for registering a first user with a first registration number and processing information on the first user and for allowing a second user to log on and access the server who received the first registration number from the first user.

The electronic business card book is provided in the server and associated with the second user for organizing information associated the first registration number, and the second user accesses the server with the first registration number and retrieves the information from the server.

The server is logged on and accessed by the second user through an Internet website or a mobile communication device, and wherein the electronic business card book is accessed in order to consult the information on the first business card.

Still another aspect of the invention provides a system for organizing business cards comprising a server, a business card, and a terminal.

The server is for registering a first user with a registration number and processing information on the first user.

The business card is associated with the first user, comprising a registration number and information on the server along with personal or business information of the first user.

The terminal is for accessing the server in order to retrieve the personal or business information of the first user.

A second user who received the business card accesses the server through an Internet website or a mobile communication device using the registration number and the information on the server, and downloads and organizes the personal or business information of the first user.

Still certain embodiments of the invention includes steps for:

(1) Business card issuer creates the business card and sends out the image file & information to be stored in server for distribution;

(2) The Server processes the information and prepares it to be downloaded to any email program, iPhone®, Black Berry® or any new electronic device for any recipient who provides the registration number. The information is in unified format to be stored and organized in any email system and electronic mobile device. The server sends out the registration number to the business card issuer;

(3) Business Card Issuer finishes the business card design with the registration number printed on the business card, produces business cards, and hands them out to the recipients;

(4) The recipient who received the card goes to home or office and goes on-line to visit the website of the server to open up the account and to download the electronic business card book template and software to enable the collaboration of email system with the server to have contact information automatically organized in the email system. The recipient types in log-in ID and password to log in then, types in the registration number of the business card, and throws away the paper business card the recipient received from the issuer;

(5) The business card image gets downloaded and placed in the e-business card book of the recipient according to the intention of recipient in personal computer or mobile device and all the contact information in the business card gets downloaded and automatically organized in email system contact information list (Gmail®, Hotmail®, Outlook Express®, iPhone®, Black Berry® or any new electronic device) in personal computer or mobile device. The image of the business card and anything the business card issuer intended and preauthorized will be downloaded and organized in the personal computer or mobile device of the recipient according to the desire or preprogrammed order of the recipient; and

(6) The copy of organized e-business card book and contact information list in recipient's personal computer or mobile device is saved in server for remote access and back up for personal computer and mobile device and other creative use.

The advantages of the present invention are: (1) the method for organizing business enables the user to organize the business cards efficiently; and (2) the method and systems for organizing business enables the user to utilize the business cards remotely.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing a system for organizing business cards according to an embodiment of the invention;

FIG. 2 is a diagram showing a business card according to an embodiment of the invention;

FIG. 3 is a flowchart showing a method for organizing business according to an embodiment of the present invention;

FIG. 4 is a block diagram showing a system for organizing business according to an embodiment of the present invention;

FIG. 5 is a block diagram showing a system for organizing business according to another embodiment of the present invention; and

FIG. 6 is a block diagram showing a method for organizing business according to still another embodiment of the present invention.

### DETAILED DESCRIPTION EMBODIMENTS OF THE INVENTION

A business person, who is currently using the business card or need to create new one, can send their business card or the digital file to an entity (BESTBCARD) to have them scanned, digitized or upload in the server. The server will store and organize the information to be downloaded for the recipient/consumers according to the desired categories. I like to call this process “Registering.” For instance, it could be categorized and be ready to be sorted by the type of business, name of the owner, region, specialty, or anything the recipient/consumer desires. This registering process may be the revenue stream for the company. The special bar code, sign or a number from, for an example, BESTBCARD.com will be issued for each business card registered. This number will be used to download the business card image and information on the card and anything business person programmed to be downloaded. All the information will be organized according to the categories predetermined by recipient, just by typing in the registration number. The recipient will not have to buy any expensive special business card scanner and will not have to scan or type in all the information.

Once, the recipient types in the registration number, all the information will be downloaded and organized to any email system such as Gmail, Hotmail, yahoo-email, outlook express, or any email system, according to its organizing features. The contact name, business name, telephone, cell, fax, email, website and anything there is to be organized. It might be necessary to contact the e-mail service providers to find out how they can collaborate with this new system. They might reject. If so, I may have to develop new software. If things go well, this could be another revenue stream. The recipient will not have to type in the information on the card but, they will have to visit the website BESTBCARD.com to type in the registration number. This will create website traffic and may create opportunity to post the advertisement targeted for business people. Lot of companies that target the business people might be interested in placing their advertisement there. This could be good source to generate revenue also.

The business person will have to print the registration number on their existing business card or he may just text it or sends an email to provide the registration number to the recipient/consumers. The recipient/consumer may enter the number on their personal website with BESTBCARD.com to have it automatically downloaded and organized for them in the server. It will also be ready to be downloaded to their iPhone®, BlackBerry® or any new electronic gadget. The downloading it to their iPhones® or cell phones could be revenue stream also.

The recipient/consumer, who wants to digitize all the business cards they have already and get rid of actual printed copy, may request the BESTBCARD.com through existing account to send packet for pick-up service. When BESTCARD.com receives the business cards, it could digitize them for the customer for small amount of fees and send original back to the customer. All the information on each and every business card will be sent to customer to be organized and stored in their email system or sent to the cell phone. The separate e-business card book or new software could be created for them also. The customers will have access to their e-business card book anywhere in the world through the remote server.

Another option to accommodate the needs of the customer is the following: the customer may scan the business card they have already by themselves and organize them on the BESTBCARD website. Once, all their necessary business cards are scanned and organized in BESTCARD.com, they can access and download them to any device such as iPhone® or BlackBerry®. So, they will never have to physically carry the business cards or card organizer. The image of the business cards will show in their iPhone® or virtual business card organizer on the BESTBCARD.com website. BESTBCARD.com will change the way people organize, carry, store, and distribute the business cards. BESTBCARD may charge for this service or do it for free at the beginning of the business to broaden the customer base and actually make profit by advertising.

When people get used to this convenient, and more secure way to organize, carry, distribute, and store the business cards, current form of storing and organizing paper business card will become ancient history. All the business cards they need to carry will be in digital format and stored in their iPhone®, BlackBerry® or some new electronic device they carry. We are living in digital age. But the printed business card will remain as the most convenient way to introduce someone and the company because all you have to do is just to hand it out. You do not have to ask anything or say anything. This new system will not drive out the current printed business card but enhance, support and improve it. The BESTBCARD.com will revolutionize the way people organize, carry, distribute, and store the business cards.

If it can get the major email service providers to collaborate and cooperate, there could be many different revenue sources to support the business.

Market Segment: Everyone who is using business card and the ones will be in need of business card regardless of the demographic, geographic, psychographic, and behavioral boundaries. All the entrepreneurs, sales people, government and not-for profit agents, organizations and existing business owners who use the business card to introduce them and their business.

Targeting: Global, International Patent is required if possible.

Positioning: Positioned as the best way all business cards should be produced, maintained, distributed, organized, stored, and carried.

Product Life Cycle: Might take a year or two to be well known to the public. I may take off and it may go on until better system is invented.

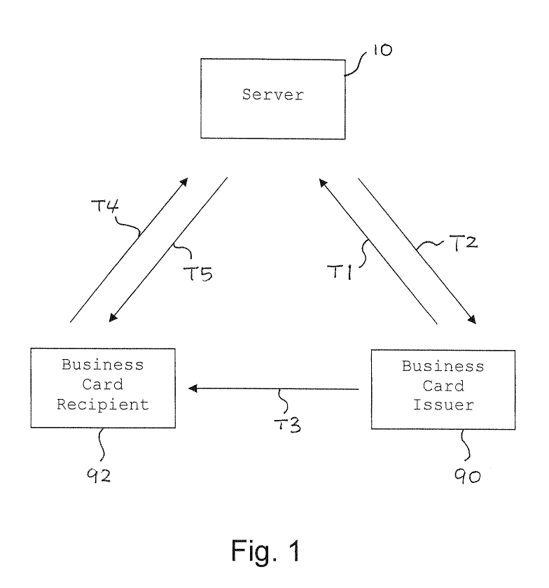

Referring FIG. 1,

T1: Business card issuer creates the business card and sends out the image file & information to be stored in server for distribution.

T2: The Server processes the information and prepares it to be download by anyone recipient who provides the registration number to any email program, iPhone®, Black Berry® or any new electronic device. The information is in unified format to be stored and organized in any email system and electronic device software. The server sends out the registration number.

T3: Business Owner finishes the business card design with the registration number printed on the business card produces and hand them out to the recipients.

T4: The recipient who received the card goes to home or office and go on-line to visit the BESTBCARD.com. He types in log-in ID, password to open his personal website than, types in the registration number of the business card and throws away the paper business card.

T5: All the information in the business card gets downloaded and organized in his ebusiness card book and email system (Gmail®, Hotmail®, Outlook Express®, iPhone®, Black Berry® or any new electronic device). The image of the business card and anything the business owner intended and preauthorized by the recipient will be downloaded and organized according to preprogrammed order by the recipient. The recipient does not have to scan or type in anything.

T6: All the information is organized and stored in server also according to the webpage customized by the recipient for remote access, back up and other creative use.

An aspect of the invention provides a method for organizing business cards.

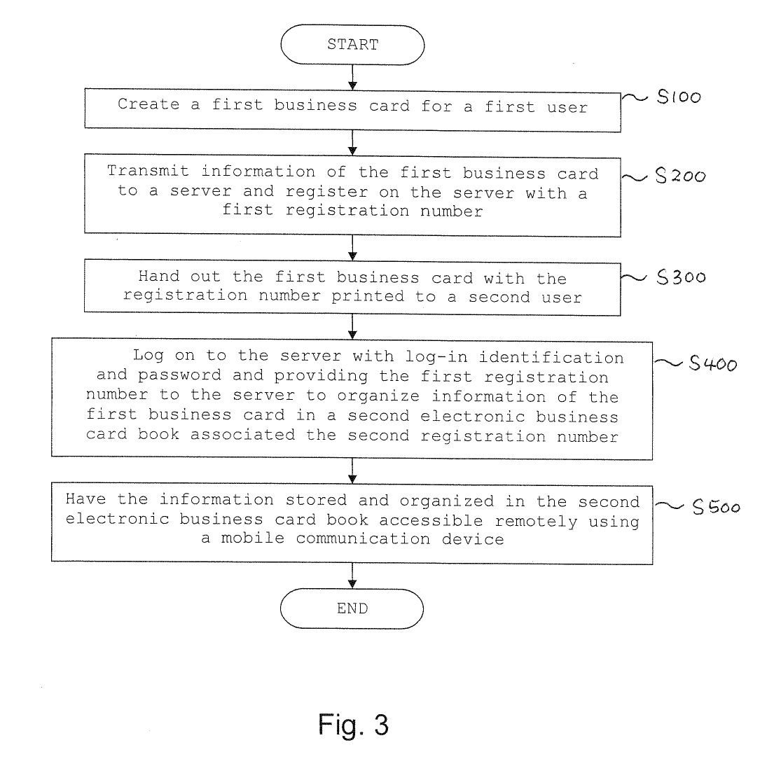

FIGS. 1-5 show method and systems for organizing business according to an embodiment of the present invention.

The method comprises steps of: creating a first business card 20 associated with a first user 90 (S100); transmitting information of the first business card 20 to a server 10 and registering on the server 10 with a first registration number 15, wherein the first business card 20 comprises the first registration number 15 (S200); handing out the first business card 20 to a second user 92 (S300); the second user's logging on to the server 10 with log-in identification and password and providing the first registration number 15 to the server 10 for organizing information of the first business card 20 in a log-in identification and password (S400); and the second user's having the information stored and organized in the second electronic business card book 12 accessible using a mobile communication device or a personal computer 30 (S500).

In certain embodiments, the first user 90 may be called an issuer, and the second user 92 may be called a recipient.

The second user 92 may obtain the log-in identification and password from the server 10, and be provided with the second electronic business card book 12.

The transmitted information in the step of transmitting (S200) may comprise a physical business card, digitized visual information, a graphic design in digital format, and text information.

In certain embodiments of the invention, the first user 90 may provide information by text only and have the server 10 print out a batch of physical business cards as the first business card 20.

The step of organizing may comprise steps of scanning, digitizing, and organizing-and-uploading on the server for downloading. That is, the first user 90 may transmit a digitized version or a scanned image of the first business card 20.

The mobile communication device 30 may comprise a cellular phone, a personal digital assistant, an e-book reader, an Internet browser, and an email system based on an Internet browser or a mobile communication network.

The step of organizing may comprise steps of categorizing, sorting, and searching according to a plurality of criteria.

The plurality of criteria may comprise type of business, name of owner, region, and specialty.

The step of creating (S100) may comprise steps of designing and creating a physical business card or a digital business card and receiving information on business card from outside.

The digital business card 20 may be downloaded and utilized by the mobile communication device 30.

The digital business card 20 may comprise a plurality of clickable zones 11, 13 configured to be displayed in the mobile communication device 30. The plurality of clickable zones 11, 13 may be configured to perform corresponding functions, and the corresponding functions may comprise putting a phone call on the mobile communication device 30, accessing a map service, and launching an web-browser to access a website.

The server 10 may be associated with an Internet website.

The Internet website may be accessed by the second user 92 with a first registration number 15 in order access and utilize information associated with the first business card 20.

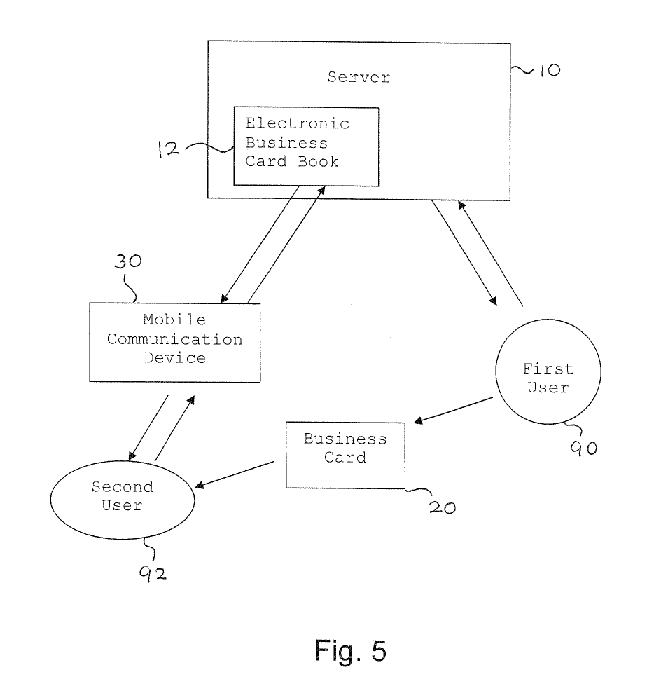

The method may further comprise steps of downloading information associated with a specific business card and displaying an image of the specific business card on the mobile communication device 30 as shown in FIG. 5.

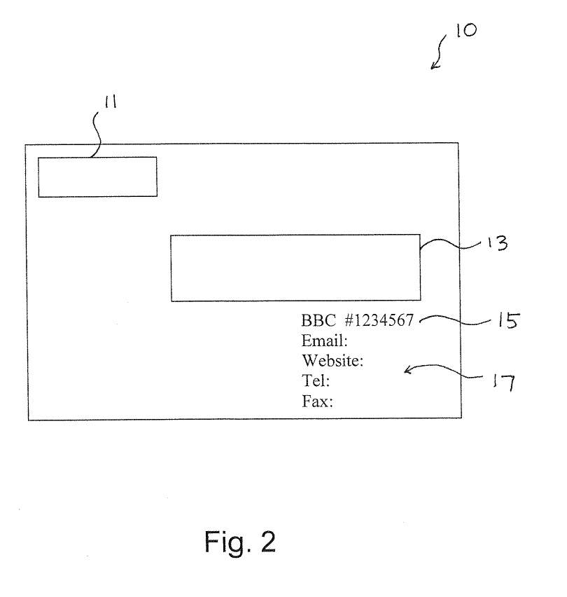

That is, the business card 20 comprises the clickable fields 11, 13, the registration number 15, and other information 17 as shown in FIG. 2, which may be a physical business card or a digital business card that can be displayed on the mobile communication device 30. The calickable fields 11, 13 and other fields 15, 17 of the digital business card may be all clickable when displayed on the mobile communication device 30.

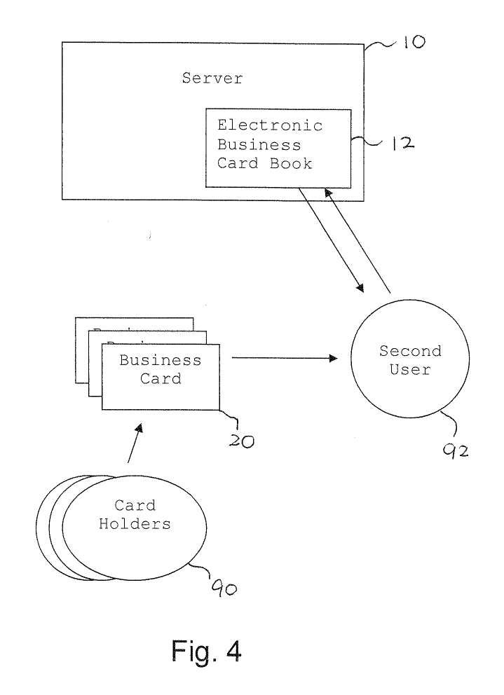

The Internet website may provide a service of accepting a plurality of business cards 20 with registration numbers from the second user 92 and inputting and organizing the processed information on the plurality of business cards 20 in the second electronic business card book 12 as shown in FIGS. 4 and 5. For example, the website information 17 may be clicked on the mobile communication device 30 to open and access the website on the mobile communication device 30.

The business card 20 may further comprise information on the Internet website 17 along with the registration number 12. The second user 92 who received the first business card 20 from the first user 90 may be acquainted with the website 17 associated with the server 10 for the first time.

The step of handing out (S300) may comprise steps of sending the first registration number 15 or a digital image of the first business card 20 having the first registration number 15 electronically, and inputting the first registration number 15 to the second user's mobile communication device 30 or the personal computer directly as shown in FIG. 5.

A copy of the second electronic business card book 12 may be maintained and updated in the server 10.

Alternatively, the copy of the second electronic business card book 12 may be maintained and updated in the mobile communication device 30 or the personal computer.

Another aspect of the invention provide a system for organizing business cards as shown in FIG. 4.

The system comprises a server 10 and an electronic business card book 12.

The server 10 is for registering a first user 90 with a first registration number 15 (provided on the first business card 20 as shown in FIG. 2) and processing information on the first user 90 and for allowing a second user 92 to log on and access the server 10 who received the first registration number 15 from the first user 90.

The electronic business card book 12 is associated with the second user 92 for organizing information associated the first registration number 15, and the second user 92 accesses the server 10 with the first registration number 15 and retrieves the information from the server 10.

The server 10 is logged on and accessed by the second user 92 through an Internet website or a mobile communication device 30, and the electronic business card book 12 is accessed in order to consult the information on the first business card 20.

The server 10 provides a template of the electronic business card book 12 to the second user 92, and the second user 92 maintains the electronic business card book 12 in the mobile communication device 30 or the personal computer.

The server 10 may provide a template of the electronic business card book 12 to the second user, and the second user may maintain the electronic business card book 12 in the server 10, in the mobile communication device 30, or in the server 10 and the mobile communication device 30.

A content of electronic business card book 12 may be deseminated in an email system through the mobile communication device 30 or the personal computer. Therefore, once a new information is added or updated in the electronic business card book 12, the new information can be broadcast and deseminated to an email account in the email system on the Internet.

Still another aspect of the invention provides a system for organizing business cards 20 comprising a server 10, a business card 20, and a terminal 30 as shown in FIG. 5. The terminal 30 may comprise a mobile communication device.

The server 10 is for registering a first user 90 with a registration number 15 and processing information on the first user 90.

The business card 20 is associated with the first user 90, comprising a registration number 15 and information on the server 10 along with personal or business information of the first user 90.

The terminal 30 is for accessing the server 10 in order to retrieve the personal or business information of the first user.

A second user 92 who received the business card 20 accesses the server 10 through an Internet website or a mobile communication device 30 using the registration number 15 and the information on the server 10, and downloads and organizes the personal or business information of the first user 90 in an electronic business card book 12 stored and maintained in the terminal 30. In certain embodiments of the invention the terminal 30 may comprise a mobile communication device or a personal computer.

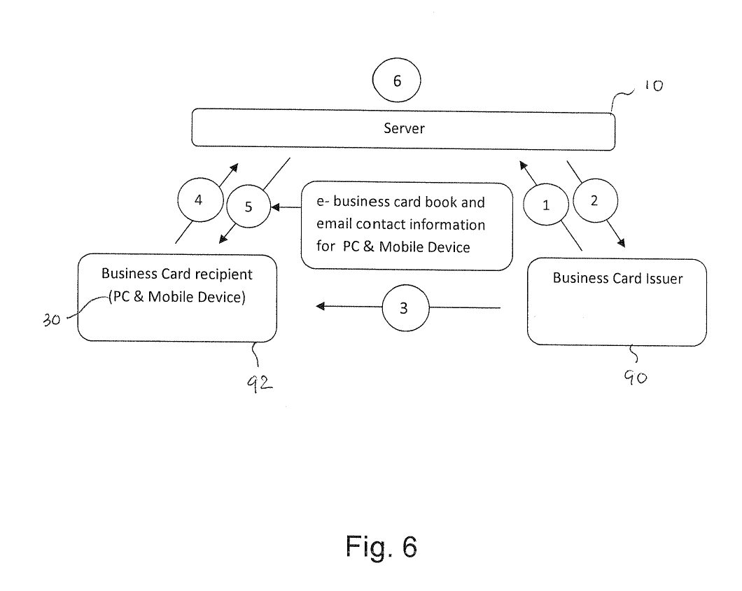

Still certain embodiments of the invention is shown in FIG. 6.

(1) Business card issuer 90 creates the business card and sends out the image file & information to be stored in server 10 for distribution.

(2) The Server 10 processes the information and prepares it to be downloaded to a mobile communication device 30 including any email program, iPhone®, Black Berry® or any new electronic device for any recipient who provides the registration number. The information is in unified format to be stored and organized in any email system and electronic mobile device. The server 10 sends out the registration number to the business card issuer 90.

(3) The business card issuer 90 finishes the business card design with the registration number printed on the business card, produces business cards, and hands them out to the recipients 92.

(4) The recipient 92 who received the card goes to home or office and goes on-line to visit the website of the server 10 to open up the account and to download the electronic business card book 12 template and software to enable the collaboration of email system with the server 10 to have contact information automatically organized in the email system. The recipient 92 types in login ID and password to log in then, types in the registration number of the business card, and throws away the paper business card the recipient received from the issuer 90.

(5) The business card image gets downloaded and placed in the e-business card book 12 of the recipient 92 according to the intention of recipient 90 in personal computer or mobile device 30 and all the contact information in the business card gets downloaded and automatically organized in email system contact information list (Gmail, Hotmail, Outlook Express, iPhone®, Black Berry® or any new electronic device) in personal computer or mobile communication device 30. The image of the business card and anything the business card issuer 90 intended and preauthorized will be downloaded and organized in the personal computer or mobile communication device 30 of the recipient 92 according to the desire or preprogrammed order of the recipient 92.

(6) The copy of organized e-business card book 12 and contact information list in recipient's personal computer or mobile communication device 30 is saved in the server 10 for remote access and back up for personal computer and mobile communication device 30 and other creative use.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A method for organizing business cards comprising steps of:
creating a first business card associated with a first user;
transmitting information of the first business card to a server and registering on the server with a first registration number, wherein the first business card comprises the first registration number;
handing out the first business card to a second user;
the second user's logging on to the server with log-in identification and password and providing the first registration number to the server for organizing information of the first business card in a second electronic business card book; and
the second user's having the information stored and organized in the second electronic business card book accessible using a mobile communication device or a personal computer.

2. The method of claim 1, wherein the transmitted information in the step of transmitting comprises a physical business card, digitized visual information, a graphic design in digital format, and text information.

3. The method of claim 1, wherein the step of transmitting comprises steps of scanning, digitizing, and organizing-and-uploading on the server for downloading.

4. The method of claim 1, wherein the mobile communication device comprises a cellular phone, a personal digital assistant, an e-book reader, an Internet browser, and an email system based on an Internet browser or a mobile communication network.

5. The method of claim 1, wherein the step of organizing comprises steps of categorizing, sorting, and searching according to a plurality of criteria.

6. The method of claim 5, wherein the plurality of criteria comprise type of business, name of owner, region, and specialty.

7. The method of claim 1, wherein the step of creating comprises steps of designing and creating a physical business card or a digital business card and receiving information on business card from outside.

8. The method of claim 7, wherein the digital business card is downloaded and utilized by the mobile communication device.

9. The method of claim 8, wherein the digital business card comprises a plurality of clickable zones configured to be displayed in the mobile communication device, wherein the plurality of clickable zones are configured to perform corresponding functions, and wherein the corresponding functions comprises putting a phone call on the mobile communication device, accessing a map service, and launching an web-browser to access a website.

10. The method of claim 1, wherein the server is associated with an Internet website.

11. The method of claim 10, wherein the Internet website is accessed by the second user with a first registration number in order to access and utilize information associated with the first business card.

12. The method of claim 10, further comprising steps of downloading information associated with a specific business card and displaying an image of the specific business card on the mobile communication device or the personal computer.

13. The method of claim 10, wherein the Internet website provides a service of accepting a plurality of business cards with registration numbers from the second user and inputting and organizing the processed information on the plurality of business cards in the second electronic business card book.

14. The method of claim 13, wherein the business card further comprises information on the Internet website along with the registration number.

15. The method of claim 1, wherein the step of handing out comprises steps of sending the first registration number or a digital image of the first business card having the first registration number electronically, and inputting the first registration number to the second user's mobile communication device or the personal computer directly.

16. The method of claim 1, wherein a copy of the second electronic business card book is maintained and updated in the server.

17. The method of claim 1, wherein a copy of the second electronic business card book is maintained and updated in the mobile communication device or the personal computer.

18. A system for organizing business cards comprising:
a server for registering a first user with a first registration number and processing information on the first user and for allowing a second user to log on and access the server who received the first registration number from the first user; and
an electronic business card book associated with the second user for organizing information associated the first registration number, wherein the second user accesses the server with the first registration number and retrieves the information from the server,
wherein the server is logged on and accessed by the second user through an Internet website or a mobile communication device, and wherein the electronic business card book is accessed in order to consult the information on a first business card associated with the first user, the business card comprising a registration number and information on the server along with personal or business information of the first user,
wherein the server provides a template of the electronic business card book to the second user, and wherein the second user maintains the electronic business card book in the mobile communication device or personal computer,
wherein a content of the electronic business card book is deseminated in an email system through the mobile communication device or personal computer.

19. The system of claim 18, further comprising a terminal for accessing the server in order to retrieve the personal or business information of the first user,
wherein a second user who received the business card accesses the server through an Internet website or a mobile communication device using the registration number and the information on the server, and downloads and organizes the personal or business information of the first user in an electronic business card book stored and maintained in the terminal.

20. A method for organizing business cards comprising steps of:
a business card issuer's creating a business card and sending out an image file and information associated with the business card to be stored in a server for distribution;
the server's processing the information and preparing it so as to be downloaded to a mobile communication device, a personal computer, or an email system for a recipient who provides the registration number, wherein the information is configured to be in unified format to be stored and organized in the mobile communication device, the email system, or the personal computer, and wherein the server sends out the registration number to the business card issuer;
the business card issuer's finishing a business card design with the registration number printed on the business card, produces business cards, and handing the printed business card out to the recipient;
the recipient's receiving the card goes to home or office and going on-line to visit the website of the server to open up the account and to download the electronic business card book template and software to enable the collaboration of email system with the server to have contact information automatically organized in the email system, wherein the recipient types in log-in ID and password to log in the server, types in the registration number of the business card, and throws away the paper business card received from the issuer;
the recipient's downloading the business card image and placing in the e-business card book in the personal computer, the email system, or the mobile communication device and all the contact information in the business card gets downloaded and automatically organized in the email system contact information list, or in the personal computer or the mobile communication device, wherein the recipient downloads information, that the business card issuer intended and preauthorized, comprising the image of the business card and organizes in the personal computer, the email system, or the mobile communication device of the recipient according to a desire or preprogrammed order of the recipient; and
saving a copy of organized e-business card book and a contact information list in recipient's personal computer, email system, or mobile communication device in the server for accessing remotely and backing up for the personal computer, the email system, or the mobile communication device.
